(19) United States
(12) Patent Application Publication
(10) Pub. No.: US 2010/0204057 A1
(43) Pub. Date: Aug. 12, 2010

(54) SUBSTRATE FOR MICROARRAY, METHOD OF MANUFACTURING MICROARRAY USING THE SAME AND METHOD OF OBTAINING LIGHT DATA FROM MICROARRAY

(75) Inventors: Kyu-sang LEE, Ulsan (KR); Dae-soon SON, Seoul (KR); Kyung-hee PARK, Seoul (KR); Tae-jin AHN, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/691,053

(22) Filed: Jan. 21, 2010

(30) Foreign Application Priority Data
Feb. 10, 2009 (KR) 10-2009-0010790
Feb. 17, 2009 (KR) 10-2009-0013139

(51) Int. Cl. C40B 30/04; C40B 40/00; C40B 40/06; C40B 50/18; C40B 60/14

(52) U.S. Cl. 506/9; 506/13; 506/16; 506/32; 506/40

(57) ABSTRACT

Provided is a substrate that is used to produce a microarray, wherein the substrate includes; a fiducial mark disposed on the substrate, and a probe immobilization region disposed on the substrate, wherein a surface of the first fiducial mark is a hydrophobic and a probe immobilization compound is immobilized on the probe immobilization region.

### CROSS-REFERENCE TO RELATED APPLICATIONS

This application claims priority to Korean Patent Application No. 10-2009-0013139, filed on Feb. 17, 2009 and Korean Patent Application No. 10-2009-0010790, filed on Feb. 10, 2009, and all the benefits accruing therefrom under 35 U.S.C. §119, the contents of which in their entirety are herein incorporated by reference.

### BACKGROUND

1. Field

One or more embodiments of the present invention relate to a substrate for a microarray, a method of manufacturing a microarray using the same and a method of obtaining light data from a microarray.

2. Description of the Related Art

Microarrays typically consist of probe materials that are bound to a target material and immobilized in a plurality of distinct regions on a substrate. Microarrays are used in various target material assays. Target materials are assayed by contacting a sample containing a fluorescent material-labeled target material with probe materials of the microarray and measuring a light signal emitted from a reaction product generated by the probe materials and the fluorescent material-labeled target material.

In general, since microarrays include a high density of independent regions (hereinafter also referred to as ‘spots’) in which possibly many different types of probe materials are immobilized, thousands or tens of thousands or more spots are irradiated and detected in a single experiment in order to determine whether a sample contains a target material which may be bound to the probe materials. Thus, a manipulator who assays image data obtained from microarray assay results generates a grid or pattern of microarray spot sites before evaluating brightness of each hybridized spot and regional background prior to quantification of image signals obtained from the microarrays. In other words, prior to analyzing the results of the assay, the manipulator produces a grid to more easily perform the analysis. Microarray grids are templates used in detection software for more efficiently searching for a location of each spot in a pattern. Thus, there is a need to efficiently identify the site of each spot using light data obtained from a microarray including many spots.

Conventional methods of identifying the sites of spots include a method of manually identifying spots on a light image using known spot information and a method using robotic spot placement equipment.

However, even with the methods described above, there is still a need to develop an assay method for easily searching for the site of each spot using light data obtained from a microarray.

### SUMMARY

One or more embodiments of the present invention include a substrate that is used to produce a microarray from which light data is easily obtained and a method of manufacturing the substrate.

One or more embodiments of the present invention include a microarray from which light data is easily obtained.

One or more embodiments of the present invention include a method of obtaining light data from a microarray.

In one embodiment, a substrate that is used to produce a microarray, the substrate includes; a first fiducial mark disposed on the substrate, and a probe immobilization region on the substrate, wherein a surface of the first fiducial mark is hydrophobic and a probe immobilization compound is immobilized on the probe immobilization region.

In one embodiment, the first fiducial mark includes a region of the substrate from which an oxide layer is removed.

In one embodiment, the region of the substrate from which an oxide layer is removed includes one of a surface of the substrate and a surface of the substrate coated with a hydrophobic material.

In one embodiment the substrate further includes a second fiducial mark.

In one embodiment, the second fiducial mark includes at least two pillars formed on the surface of the substrate.

In one embodiment, the second fiducial mark includes a material that strongly interacts with a target material immobilized on the surface of the substrate.

An embodiment of a microarray includes; a first fiducial mark disposed on a substrate and a region of the substrate on which a probe material is immobilized, wherein a surface of the first fiducial mark is hydrophobic.

In one embodiment, the first fiducial mark includes a region of the substrate from which an oxide layer is removed.

In one embodiment, the region of the substrate from which an oxide layer is removed includes one of a surface of the substrate and a surface of the substrate coated with a hydrophobic material.

In one embodiment, the microarray, further includes a second fiducial mark.

In one embodiment, the second fiducial mark includes at least two pillars formed on the surface of the substrate.

In one embodiment, the second fiducial mark includes a material which strongly interacts with a target material and is immobilized on the surface of the substrate.

In one embodiment, adjacent pillars of the at least two pillars are spaced apart by an interval of about 0.1 μm to about 1000 μm, and a dimension of a cross-section of each pillar is in the range of about 0.1 μm to about 1000 μm.

An embodiment of a method of manufacturing a substrate for a microarray includes; providing a substrate on which an oxide layer is formed, wherein the substrate has a surface which is hydrophobic, coating photoresist on the oxide layer to form a photoresist layer, irradiating light to the photoresist layer through a mask, developing the photoresist layer and etching a portion of the oxide layer which is not protected by the photoresist layer to expose the surface of the substrate, and immobilizing a probe immobilization compound on a portion of the substrate that does not include the surface which is hydrophobic.

In one embodiment, the etching includes a dry etching process using a hydrophobic material.

An embodiment of a method of manufacturing a probe microarray includes; providing a substrate on which an oxide layer is disposed, wherein the substrate has a surface which is hydrophobic, coating photoresist on the oxide layer to form a photoresist layer, irradiating light to the photoresist layer through a mask, developing the photoresist layer and etching a portion of the oxide layer which is not protected by the photoresist layer to expose the surface of the substrate, immobilizing a probe immobilization compound on a portion of the substrate that does not include the surface which is hydrophobic, and immobilizing a probe material on a plurality of distinct regions on the portion of the substrate on which the probe immobilization compound is immobilized.

In one embodiment, a method of manufacturing a substrate for a microarray includes; providing a substrate on which an oxide layer is disposed, coating photoresist on the oxide layer to form a photoresist layer, irradiating light to the photoresist layer through a mask, developing the photoresist layer and etching a portion of the oxide layer which is not protected by the photoresist layer to expose a surface of the substrate, wherein the etching includes a dry etching process using a hydrophobic material, and immobilizing a probe immobilization compound on a portion of the substrate that does not include a surface that is hydrophobic.

In one embodiment, the hydrophobic material includes fluorocarbon.

An embodiment of a method of manufacturing a probe microarray includes; providing a substrate on which an oxide layer is disposed, coating photoresist on the oxide layer to form a photoresist layer, irradiating light to the photoresist layer through a mask, developing the photoresist layer and etching a portion of the oxide layer which is not protected by the photoresist layer to expose a surface of the substrate, wherein the etching includes a dry etching process using a hydrophobic material, immobilizing a probe immobilization compound on a portion of the substrate which does not include a surface which is hydrophobic, and immobilizing a probe material on a plurality of distinct regions on the portion of the substrate on which the probe immobilization compound is immobilized.

In one embodiment, a method of obtaining light data from a microarray including a first fiducial mark, a second fiducial mark and a region in which a probe material is immobilized, the method includes; contacting a target material labeled with a light emitting material with the microarray, wherein the first fiducial mark has a hydrophobic surface, irradiating light to the microarray, measuring light generated from the microarray due to the irradiated light in order to generate light data, identifying the first fiducial mark and the second fiducial mark from the light data, identifying the region in which a probe material is immobilized with reference to the identified first and second fiducial marks, and obtaining light data from the identified region in which a probe material is immobilized.

In one embodiment, in the identifying of the first fiducial mark and the second fiducial mark, the first fiducial mark is identified by referring to a degree of how low the light intensity of the first fiducial mark is compared to regions surrounding the first fiducial mark.

In one embodiment, the identifying of the first fiducial mark and the second fiducial mark, the second fiducial mark is identified by referring to how high the light intensity of the second fiducial mark is compared to regions surrounding the second fiducial mark.

In one embodiment, in the identifying of the first fiducial mark and the second fiducial mark, the first fiducial mark is identified by referring to how low the light intensity of the first fiducial mark is compared to regions surrounding the first fiducial mark, and the second fiducial mark is identified by referring to how high the light intensity of the second fiducial mark is compared to the regions surrounding the first fiducial mark and the first fiducial mark and the second fiducial mark are identified by the relative location of the first and second fiducial marks to each other.

In one embodiment, the second fiducial mark includes at least two pillars formed on a surface of a substrate.

In one embodiment, the second fiducial mark includes a material that strongly interacts with the target material immobilized on the surface of the substrate.

An embodiment of a microarray includes; a first distinct region disposed on a substrate, a second distinct region disposed on the substrate, and a third distinct region disposed on the substrate, wherein a probe nucleic acid is immobilized on the third distinct region, the probe nucleic acid has a sequence complementary to that of a target nucleic acid, a binding force between the first distinct region and a target nucleic acid labeled with one of a detectable mark and a target material labeled with a detectable mark is weaker than a binding force between the second distinct region and the target material labeled with a detectable mark, and the binding force between the second distinct region and the target material labeled with a detectable mark is equal to or stronger than a binding force between the probe nucleic acid in the third distinct region and the target material labeled with a detectable mark.

In one embodiment, a detection signal obtained from the second distinct region is stronger than a detection signal obtained from the first distinct region when the first distinct region and the second distinct region are reacted with the target nucleic acid labeled with one of a detectable mark and the target material labeled with a detectable mark.

In one embodiment, when the detection signal includes a fluorescent light signal, the fluorescent light signal obtained from the second distinct region is stronger than the fluorescent light signal obtained from the first distinct region.

In one embodiment, a combination of the first distinct region and the second distinct region are arranged such that when reacted with one of the target nucleic acid labeled with a detectable mark and the target material labeled with a detectable mark, detection signals obtained from the first distinct region and the second distinct region are discerned from a detection signal obtained from the third distinct region.

In one embodiment, the combination of the first distinct region and the second distinct region has an arrangement such that when subjected to the same reaction, the detection signal obtained from the third distinct region has low probability for accidentally having the same arrangement.

In one embodiment, the combination of the first distinct region and the second distinct region has an alphanumeric shape.

In one embodiment, the microarray includes a plurality of panels, and a plurality of combinations of the first distinct region, the second distinct region and the third distinct region are arranged in each of the plurality of panels of the microarray.

In one embodiment, each of the panels of the microarray is tetragonal and the combinations of the first distinct region, the second distinct region and the third distinct region are arranged in respective four corners of each of the panels.

In one embodiment, the first distinct region includes a hydrophobic material, and the target nucleic acid labeled with a detectable mark and the target material labeled with a detectable mark includes a hydrophilic material.

In one embodiment, the second distinct region is immobilized with a material that binds to the target material labeled with a detectable mark.

In one embodiment, the second distinct region has a surface characteristic that binds to the target material labeled with a detectable mark.

In one embodiment, the second distinct region is immobilized with biotin, and the target material labeled with a detectable mark includes streptavidin labeled with a detectable mark.

In one embodiment, the second distinct region is immobilized with a nucleic acid which is longer than a probe nucleic acid immobilized on the surface of the third distinct region, and the target material labeled with a detectable mark includes a nucleic acid complementary to the probe nucleic acid.

An embodiment of a method of assaying a microarray signal wherein the microarray includes a first distinct region disposed on a substrate, a second distinct region disposed on a substrate, and a third distinct region disposed on a substrate, wherein a probe nucleic acid is immobilized on the third distinct region, the probe nucleic acid has a sequence complementary to that of a target nucleic acid, a binding force between the first distinct region and a target nucleic acid labeled with one of a detectable mark and a target material labeled with a detectable mark is weaker than a binding force between the second distinct region and the target material labeled with a detectable mark, and the binding force between the second distinct region and the target material labeled with a detectable mark is equal to or stronger than a binding force between the probe nucleic acid in the third distinct region and the target material labeled with a detectable mark, the method includes; obtaining a signal from a reaction product produced by reacting the microarray with a sample including at least one of the target nucleic acid labeled with a detectable mark and the target material labeled with a detectable mark, and discerning signals obtained from the third distinct region by referring to signals obtained from the first distinct region and the second distinct region.

An embodiment of a method of manufacturing a microarray includes; providing a substrate, disposing an oxide layer on the substrate, patterning the oxide layer to form at least two columns, and disposing a probe immobilization compound on the at least two columns, wherein a region between the at least two columns functions as a first fiducial mark, and the columns and probe immobilization compound function as a second fiducial mark having different light reflectance characteristics than the first fiducial mark.

### BRIEF DESCRIPTION OF THE DRAWINGS

These and/or other aspects will become apparent and more readily appreciated from the following description of the embodiments, taken in conjunction with the accompanying drawings of which:

FIGS. 1A-C are a series of cross-sectional views illustrating an embodiment of a method of manufacturing a substrate for a microarray, wherein the substrate includes a first fiducial mark and a region in which a probe material is to be immobilized;

FIGS. 2 and 3 are diagrams illustrating at least one embodiment of a substrate for a microarray and/or a microarray;

FIGS. 4A-C are diagrams illustrating an example of a bright fiducial mark A having a structure including at least one pillar and an embodiment of a method of manufacturing the same;

FIG. 5A is a diagram illustrating a mechanism in which a pillar structure constitutes a bright fiducial mark;

FIG. 5B is a top plan view of the pillar structure illustrated in FIG. 5A;

FIGS. 6A and B show schematic images of the same structure wherein FIG. 6B is a reflected light image and FIG. 6A is a fluorescent light image;

FIG. 7 shows an example of a microarray assay image;

FIG. 8 shows a gridding embodiment in which fiducial marks and data spots are accurately arranged by referring to fiducial marks in the image shown in FIG. 7;

FIG. 9 shows a gridding embodiment in which fiducial marks and data spots are inaccurately arranged by referring to the fiducial marks in the image shown in FIG. 7; and

FIGS. 10A-E shows an image of a panel of a microarray, wherein the panel includes a plurality of combinations of a dark fiducial mark and a bright fiducial mark and the combinations have different shapes; wherein the four corners denoted by a circle are enlarged into four square images illustrated in FIGS. 10B-E, respectively.

### DETAILED DESCRIPTION

Reference will now be made in detail to embodiments, examples of which are illustrated in the accompanying drawings. In this regard, the present embodiments may have different forms and should not be construed as being limited to the descriptions set forth herein. Rather, these embodiments are provided so that this disclosure will be thorough and complete, and will fully convey the scope of the disclosure to those skilled in the art. Accordingly, the embodiments are merely described below, by referring to the figures, to explain aspects of the present description.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the disclosure.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the embodiments as used herein.

Hereinafter, the present invention will be described in detail with reference to the accompanying drawings.

An embodiment provides a substrate for a microarray. The substrate includes a first fiducial mark and a region in which a probe material is to be immobilized, wherein the first fiducial mark has a hydrophobic surface, and a probe immobilization compound is immobilized on a surface of the region in which a probe material is to be immobilized.

Embodiments of the substrate may be formed of a material selected from the group consisting of glass, quartz, silicon, plastic and other materials having similar characteristics. Embodiments also include configurations wherein an oxide layer that is naturally or artificially formed may be formed on the substrate. An example of a naturally formed oxide layer is a silicon dioxide film formed on a silicon substrate. The oxide layer may be formed on a substrate using a known method. For example, in one embodiment an oxide layer may be formed by depositing an oxide on a substrate by liquid phase deposition, evaporation, sputtering or other similar known methods.

The first fiducial mark is used to identify a region in which a probe material is immobilized in a light image profile of the substrate for a microarray. Specifically, when results of interaction between probe materials immobilized in the substrate and a target material that is bound to the probe materials are assayed, the fiducial mark is used to identify the region using optical signals. When irradiated with light, the first fiducial mark emits a fluorescent light having low or substantially low intensity compared to the region in which a probe is immobilized and/or a background region, that is, a region in which only a probe immobilization compound is immobilized. Such light emission characteristics may be obtained by lowering reactivity between a surface of the first fiducial mark and a target material labeled with a fluorescent light material. The first fiducial mark may have any shape and any structure; in other words, the fiducial mark is not limited to a particular shape or structure. For example, in one embodiment the first fiducial mark may have a letter or symbol shape. The size of the first fiducial mark shape viewed from a top plan view may have the same dimension as, or different dimension from, a region in which a probe is immobilized.

The region in which a probe is immobilized is also referred to as a “spot”, as would be know to one of ordinary skill in the art. The dimensions of the first fiducial mark shape as viewed from a top plan view may be in the range of about 0.1 μm to about 100 μm, e.g., the fiducial mark may be about 0.1 μm to about 100 μm in width and/or length. In another embodiment, when the first fiducial mark shape is viewed from the top plan view, the first fiducial mark is circular and the diameter thereof may be about 0.1 μm to about 100 μm. Otherwise, in alternative embodiments the dimension may refer to a shortest segment line formed by a line passing through the weight center of the first fiducial mark shape viewed from a top plan view and a boundary line of the first fiducial mark shape.

In one embodiment, the first fiducial mark may be a region formed by removing the oxide layer from the substrate. In one embodiment, the region may be a surface of the substrate itself from which an oxide layer is removed, or a surface coated with a hydrophobic material. In one embodiment, the hydrophobic material may be derived from a dry etching material such as fluorocarbon. In one embodiment, the fluorocarbon may be tetrafluoromethane. In this regard, the surface of the substrate may be etched using a well known dry etching process using a plasma reaction of a material.

The substrate may have a surface on which a probe immobilization compound is immobilized. In one embodiment, the surface may be the entire surface excluding the surface of the first fiducial mark, or a surface on which a probe is to be immobilized. Embodiments of the probe immobilization compound may include at least one compound selected from the group consisting of biotin, avidin, streptavidin, poly L-lysine, and compounds having an amino group, an aldehyde group, a thiol group, a carbonyl group, a succinimide group, a maleimide group, an epoxide group an isothiocyanate group and other materials with similar characteristics. Examples of a compound including an amino group include 3-aminopropyltrimethoxysilane, N-(2-aminoethyl)-3-aminopropyltrimethoxysilane (“EDA”), trimethoxysilylpropyldiethylenetriamine (“DETA”), 3-(2-aminoethylaminopropyl) trimethoxysilane, and 3-aminopropyltriethoxysilane. Examples of a compound including an aldehyde group include glutaraldehyde. Examples of a compound including a thiol group include 4-mercaptopropyltrimethoxysilane (“MPTS”). Examples of a compound including an epoxide group include 3-glycidoxypropyltrimethoxysilane. Examples of a compound including an isothiocyanate group include 4-phenylenediisothiocyanate (“PDITC”). Examples of compounds including succinimide and maleimide groups include disuccinimidyl carbonate (“DSC”) and succinimidyl 4-(maleimidephenyl) butylate (“SMPB”).

The term “microarray” may refer to an apparatus wherein a particular material, for example, a probe material which may bind to a target material, is immobilized in a distinct region of a substrate. In general, at least two distinct regions, which are also referred to as spots, are arranged with each other on a substrate. The probe material may be a biomolecular material, for example, DNA, RNA, cDNA, mRNA, protein, sugar or other similar materials.

The substrate for a microarray may further include a second fiducial mark in addition to the first fiducial mark. In one embodiment, the second fiducial mark may be positioned near the first fiducial mark. In one embodiment, the second fiducial mark may be defined by patterning the surface of the substrate. In one embodiment, the patterning may be performed using a known method. For example, embodiments of the patterning method may include photolithography. As a result of the patterning, a portion of the substrate near the second fiducial mark is removed by etching and thus, the second fiducial mark may have a pillar structure, as will be described in more detail below with respect to the figures. A horizontal cross-section of the pillar structure may be, for example, circular or tetragonal, including rectangular and square shaped, but the shape of the pillar structure is not limited thereto. An edge of the pillar structure may be slanted such that irradiation light is reflected from the slanted edge thereof. That is, the edge may be disposed such that it is not perpendicular to the substrate or a horizontal plane of the pillar. In another embodiment, the edge may be rounded. A reflection surface for reflecting irradiation light is provided by the shape of the edge of the pillar. However, such above-described shapes should not be construed as limiting the embodiments to a particular mechanism. Embodiments include configurations wherein the etching may be wet etching or dry etching.

In one embodiment, the second fiducial mark may consist of at least two pillars. The distance between adjacent pillars may be less than a diameter of a pixel of the microarray. As used herein, the pixel refers to a pixel on an image profile of a microarray obtained from the reflected light or an image profile of the intensity of fluorescent light obtained from interaction between a probe material and a target material. In one embodiment, a cross-sectional dimension of each pillar may be in the range of about 0.001 μm to about 10 μm, and adjacent pillars may be spaced apart by intervals of about 0.001 μm to about 10 μm. The second fiducial mark may include pillars arranged within a boundary having the same shape viewed from a top plan view as the shape of a spot where a probe material is to be immobilized. Embodiments include configurations wherein a reflection image of the second fiducial mark obtained from light reflected from the second fiducial mark may be substantially the same as, or different from, a fluorescent image obtained from probe spots after a probe material and a target material interact with each other.

Light may be irradiated at any angle at which the interaction between a probe material and a target material can be detected. In one embodiment, the irradiation light may enter the surface of the substrate at an angle of about 0° to about 45°. The irradiation light may be light such as light of any wavelength, or more particularly, the irradiation light may be an excitation light corresponding to a particular excitation wavelength of a fluorescent material. In one embodiment, light may be measured at an angle of about 45° to about 135° with respect to the surface of the substrate.

The substrate for a microarray may further include an alignment mark for determining a reference frame within which the locations of other elements on the microarray may be determined. The term “alignment mark” refers to a mark that allows the substrate for a microarray to be positioned at the same location with respect to a probe material immobilization device. The alignment mark ensures that the substrate for a microarray is positioned at the same location with respect to a probe material immobilization device. Thus, the location of a probe spot immobilized on the substrate, e.g., the coordinate value thereof, may be used as an objective reference value. The coordinate of the probe spot may be provided with respect to a particular site of a substrate determined by the alignment mark. For example, the location of a spot may be identified with a coordinate at which a horizontal axis meets a vertical axis by referring to the alignment mark. The first fiducial mark, second fiducial mark and spot where a probe material is immobilized may be formed at predetermined positions relative to each other in the coordinate reference frame determined by the alignment mark.

In one embodiment, the alignment mark may be a pattern formed by photolithography. For example, in one embodiment, the alignment mark may be a pattern of a cross-shaped symbol or a T-shaped letter on the substrate.

According to another embodiment, a microarray includes a first fiducial mark and a region in which a probe material is immobilized, wherein the first fiducial mark has a hydrophobic surface.

In one embodiment, the microarray may be produced by immobilizing probe materials in a plurality of distinct regions on the substrate for a microarray. In one embodiment, each of the regions may have a dimension of about 0.1 μm to about 1000 μm, and a distance between adjacent regions may be in the range of about 0.1 μm to about 1000 μm. In one embodiment, the density of the regions may be, for example, on the order of 1000 regions/cm², on the order of 10⁴ regions/cm², on the order of 10⁵ regions/cm², or on the order of 10⁶ regions/cm² or more.

In the present embodiment, the first fiducial mark is substantially the same as described above with respect to the previous embodiment.

Embodiments of the substrate may be formed of a material selected from the group consisting of glass, quartz, silicon, plastic and other materials having similar characteristics. In one embodiment, an oxide layer that is naturally or artificially formed may be formed on the substrate.

In one embodiment, the first fiducial mark may be a region formed by removing an oxide layer from a substrate. In one embodiment, the region may be a surface of the substrate itself from which an oxide layer is removed, or a surface coated with a hydrophobic material. In one embodiment, the hydrophobic material may be derived from a dry etching material such as fluorocarbon. In one embodiment, the fluorocarbon may be tetrafluoromethane.

The microarray may further include, in addition to the first fiducial mark, a second fiducial mark. In one embodiment, the second fiducial mark may be positioned near the first fiducial mark. The second fiducial mark may substantially emit bright light when exposed to an excitation light. As used herein, the term “bright light” means that the light is bright enough to be able to differentiate the second fiducial mark from other regions in consideration of known information on the second fiducial mark. For example, in one embodiment the second fiducial mark may have a brightness equivalent to or higher than that of the region in which a probe material is immobilized.

The second fiducial mark may include at least one pillar. In embodiments wherein the second fiducial mark includes two or more pillars, the interval between adjacent pillars may be in the range of about 0.001 μm to about 10 μm. In one embodiment the interval between adjacent pillar may be about 0.001 μm to about 0.01 μm. In another embodiment the interval between adjacent pillar may be about 0.001 μm to about 0.1 μm. In another embodiment the interval between adjacent pillar may be about 0.001 μm to about 1 μm. In another embodiment the interval between adjacent pillar may be about 0.001 μm to about 10 μm. In another embodiment the interval between adjacent pillar may be about 0.001 μm to about 100 μm. Embodiments of the dimension of a cross-section of each of the pillars may be in the range of about 0.001 μm to about 10 μm. In one embodiment the dimension of a cross-section of each pillar may be in the range of about 0.001 μm to about 0.01 μm. In one embodiment the dimension of a cross-section of each pillar may be in the range of about 0.001 μm to about 0.1 μm. In one embodiment the dimension of a cross-section of each pillar may be in the range of about 0.001 μm to about 1 μm. In one embodiment the dimension of a cross-section of each pillar may be in the range of about 0.001 μm to about 10 μm. In one embodiment the dimension of a cross-section of each pillar may be in the range of about 0.001 μm to about 100 μm. In one embodiment, the at least one pillar may be formed by etching the oxide layer on the substrate.

According to other embodiments, a method of manufacturing a substrate for a microarray includes; providing a substrate on which an oxide layer is formed, wherein the substrate has a surface that is hydrophobic, coating photoresist on the oxide layer to form a photoresist layer, irradiating light to the photoresist layer using a mask, exposing the surface of the substrate by developing the photoresist layer and etching a portion of the oxide layer that is not protected by the photoresist layer, and immobilizing a probe immobilization compound on a portion of the substrate that does not include the surface that is hydrophobic, as will be described in more detail below.

The method includes providing a substrate on which an oxide layer is formed. Embodiments of the oxide layer may include an oxide layer that is naturally formed, such as a silicon oxide film that is naturally formed when a silicon substrate is exposed to the atmosphere. Alternative embodiments include configurations wherein the oxide layer may be formed by depositing an oxide layer on a substrate. In the latter alternative embodiment, the oxide layer may be formed by depositing an oxide such as silicon oxide on a substrate, for example, a silicon substrate. The deposition may be performed using a known method. For example, in one embodiment an oxide layer may be formed by depositing an oxide on a substrate by liquid phase deposition, evaporation, sputtering or other similar methods. The oxide layer may have a thickness such that light reflected from the substrate and light reflected from the oxide layer cause constructive interference. In one embodiment, the oxide layer may be formed of SiO₂. However, the oxide layer may be replaced with any organic or inorganic material film that can cause constructive interference. For example, in one embodiment the oxide layer may be replaced with silicon nitride.

The method also includes coating photoresist on the oxide layer to form a photoresist layer. The coating may be performed using a known method. For example, in one embodiment the coating may be spin coating, deposition coating or another similar coating method. In one embodiment, the photoresist layer may be hardened by heating. The type of the photoresist is not limited according to a coating method and a hardening condition. For example, embodiments include configurations wherein the photoresist may be a positive photoresist or a negative photoresist.

The method also includes irradiating light to the photoresist layer using a mask. The mask may be prepared such that a first fiducial mark is formed in a desired shape and at a desired interval among first fiducial marks, second fiducial marks and/or a spot, as described above, using a method that varies according to whether the photoresist is a positive photoresist or a negative photoresist. Next, the mask is used to selectively expose the substrate to a light. The light irradiation condition may vary according to the material and type of photoresist used. Embodiments include configurations wherein the mask may have, in addition to a pattern for forming the first fiducial mark, a pattern for forming an alignment mark that allows the substrate for a microarray to be positioned in a constant location with respect to a probe material immobilization device, for example, an arrayer or a spotter, in order to immobilize a probe material more accurately thereon. Thus, the mask may be a mask that has a pattern of the alignment mark. The alignment mark may be formed using the same patterning process as that used to form the first fiducial mark, for example, by photolithography. In one embodiment, the alignment mark and the first fiducial mark may be simultaneously formed.

The method also includes exposing the surface of the substrate by developing the photoresist layer and etching a portion of the oxide layer that is not protected by the photoresist layer.

The developing of the photoresist layer may include treating the irradiated photoresist layer with a developing solution. In some embodiments, the treated photoresist layer may be further washed. The developing solution may be selected according to the type and material of photoresist used. After the development step, the portion of the oxide layer that is not protected by the photoresist layer is etched and thus, a first fiducial mark is formed. The etching may be performed using a known method. For example, in one embodiment the etching may be a dry etching process using a hydrophobic material. In one embodiment, the hydrophobic material may be fluorocarbon. In one embodiment, the fluorocarbon may be a fluoroalkane such as tetrafluoromethane. In one embodiment, the fluoroalkane may be a C1-C20 fluoroalkane. As a result of the etching, a recess portion is formed in the substrate, and a bottom and/or wall of the recess portion may have the same properties as the surface of the substrate, in particular, a hydrophobic property. In addition, in the embodiment wherein the etching is performed by dry etching using a hydrophobic material, the bottom and/or wall of the recess portion may have a hydrophobic property due to deposition of the hydrophobic material. The photoresist layer may be removed using a known method. For example, in one embodiment the photoresist layer may be removed using an organic solvent for dissolving photoresists, for example, acetone.

The substrate having the surface that is hydrophobic may be formed of a material selected from the group consisting of silicon, plastic and other similar materials. The plastic may be selected from the group consisting of polyethylene, polypropylene, polystyrene, polytetrafluoroethylene (“PTFE”) and other materials with similar characteristics.

The method also includes immobilizing a probe immobilization compound on a portion of the substrate that does not include the surface that is hydrophobic. The probe immobilization compound interacts with a probe material in order to immobilize the probe material. Embodiments of the probe immobilization compound may include, for example, at least one compound selected from the group consisting of biotin, avidin, streptavidin, poly L-lysine, and compounds having an amino group, an aldehyde group, a thiol group, a carbonyl group, a succinimide group, a maleimide group, an epoxide group, an isothiocyanate group or other materials having similar characteristics. An embodiment of the compound having an amino group may be 3-aminotriethoxysilane (“GAPS”). In the embodiment wherein the probe immobilization compound is, for example, biotin, the biotin may be immobilized by, for example, reacting biotinsuccinimidylester with an aminosilane-treated oxide layer. In the embodiment wherein the probe immobilization compound is glutaraldehyde including an aldehyde group, the glutaraldehyde including an aldehyde group may be immobilized by, for example, reacting glutaraldehyde with an aminosilane-treated oxide layer. Since the hydrophobic surface of the substrate has low or no reactivity, when the probe immobilization compound is applied to and reacted with the substrate, the probe immobilization compound is immobilized on the portion of the substrate that does not includes the surface that is hydrophobic. The probe immobilization compound applied to the hydrophobic surface may be removed later using a washing solution.

A probe material is immobilized on at least one distinct region of the various regions to which probe immobilization compounds are applied to the substrate to thereby form a microarray.

According to another embodiment, a method of manufacturing a probe microarray includes; providing a substrate on which an oxide layer is formed, wherein the substrate has a surface that is hydrophobic, coating photoresist on the oxide layer to form a photoresist layer, irradiating light to the photoresist layer using a mask, exposing the surface of the substrate by developing the photoresist layer and etching a portion of the oxide layer that is not protected by the photoresist layer, immobilizing a probe immobilization compound on a portion of the substrate that does not includes the surface that is hydrophobic, and immobilizing a probe material on a plurality of distinct regions on the portion of the substrate on which the probe immobilization compound is immobilized.

The method according to the present embodiment includes immobilizing a probe material on a plurality of distinct regions on the portion of the substrate on which the probe immobilization compound is immobilized. The probe material may be activated to be immobilized by binding to, or interacting with, the probe immobilization compound. For example, in the embodiment wherein the probe immobilization compound is avidin, the probe material may activated with biotin. In addition, in the embodiment wherein the probe immobilization compound has an amino group such as aminosilane, the probe material may have an ester bond with a succinimide group and a maleimide group, and the ester bond is coupled with the amino group, thereby immobilizing the probe material. Other operations included in the method are substantially the same as described above with respect to previous embodiments.

According to another embodiment, a method of manufacturing a substrate for a microarray includes; providing a substrate on which an oxide layer is formed, coating photoresist on the oxide layer to form a photoresist layer, irradiating light to the photoresist layer using a mask, exposing the surface of the substrate by developing the photoresist layer and etching a portion of the oxide layer that is not protected by the photoresist layer, wherein the etching is a dry etching process using a hydrophobic material, and immobilizing a probe immobilization compound on a portion of the substrate that does not include the surface that is hydrophobic.

The method according to the present embodiment includes exposing the surface of the substrate by developing the photoresist layer and etching a portion of the oxide layer that is not protected by the photoresist layer, wherein the etching is a dry etching process using a hydrophobic material.

The developing of the photoresist layer may include treating the irradiated photoresist layer with a developing solution. In some embodiments, the treated photoresist layer may be further washed. The developing solution may be selected according to the photoresist used. After the development step, the portion of the oxide layer that is not protected by the photoresist layer is etched and thus a first fiducial mark is formed. Embodiments include configurations wherein the etching may be performed using a known method. For example, in one embodiment the etching may be a dry etching process using a hydrophobic material. In one embodiment, the hydrophobic material may be fluorocarbon. In one embodiment, the fluorocarbon may be a fluoroalkane such as tetrafluoromethane. In one embodiment, the fluoroalkane may be a C1-C20 fluoroalkane. As a result of the etching, a recess portion is formed on the substrate, and a bottom and/or wall of the recess portion may have similar properties to those of the surface of the substrate, in particular, a hydrophobic property. In addition, if the etching includes dry etching using a hydrophobic material, the bottom and/or wall of the recess portion may have a hydrophobic property due to deposition of the hydrophobic material. In one embodiment, the photoresist layer may be removed using a known method. For example, in one embodiment, the photoresist layer may be removed using an organic solvent for dissolving photoresist, such as acetone.

Embodiments of the substrate may be formed of a material selected from the group consisting of glass, quartz, silicon, plastic and other materials having similar characteristics. Embodiments of the plastic may be selected from the group consisting of polyethylene, polypropylene, polystyrene, and polytetrafluoroethylene (“PTFE”). In one embodiment, the substrate may be formed of silicon and an oxide layer may be formed of SiO₂ on the substrate.

Other operations included in the method are the same as described above.

According to another embodiment, a method of manufacturing a probe microarray includes; providing a substrate on which an oxide layer is formed, coating photoresist on the oxide layer to form a photoresist layer, irradiating light to the photoresist layer using a mask, exposing the surface of the substrate by developing the photoresist layer and etching a portion of the oxide layer that is not protected by the photoresist layer, wherein the etching is a dry etching using a hydrophobic material, immobilizing a probe immobilization compound on a portion of the substrate that does not include the surface that is hydrophobic, and immobilizing a probe material on a plurality of distinct regions on the portion of the substrate on which the probe immobilization compound is immobilized.

The method of manufacturing a probe microarray according to the present embodiment includes immobilizing a probe material on a plurality of distinct regions on the portion of the substrate on which the probe immobilization compound is immobilized. The probe material may be one that is activated to be immobilized by binding to or interacting with the probe immobilization compound. For example, in an embodiment wherein the probe immobilization compound is avidin, the probe material may be one that is activated with biotin. In addition, if the probe immobilization compound has an amino group such as aminosilane, the probe material may have an ester bond with a succinimide group and a maleimide group, and the ester bond is coupled with the amino group, thereby immobilizing the probe material. Other operations included in the method are substantially the same as described above with respect to previous embodiments.

According to another embodiment, a method of obtaining light data from a microarray including a first fiducial mark and a region in which a probe material is immobilized includes; contacting a target material labeled with a light emitting material with the microarray, wherein the first fiducial mark has a hydrophobic surface, irradiating light to the microarray to measure light generated from the microarray, identifying the first fiducial mark from the obtained light data, identifying the region in which a probe material is immobilized with reference to the identified first fiducial marks, and obtaining light data from the identified region in which a probe material is immobilized.

The microarray may further include, in addition to the first fiducial mark, the second fiducial mark as described in detail above. The second fiducial mark may be positioned near the first fiducial mark. The second fiducial mark may emit bright light when irradiated to light. Herein, “bright light” means that light is bright enough to be able to differentiate the second fiducial mark from other regions given known information about the second fiducial mark. For example, in one embodiment the second fiducial mark may have a brightness equivalent to or higher than that of the region in which a probe material is immobilized.

The second fiducial mark may consist of at least one pillar. In an embodiment wherein the second fiducial mark includes at least two pillars, the interval between adjacent pillars may be in the range of about 0.001 μm to about 10 μm, and the dimension of a cross-section of each of the pillars may be in the range of about 0.001 μm to about 10 μm. Each of the pillars may have an edge that is formed in a shape allowing light irradiated thereto to be reflected. For example, in one embodiment the edge may be slanted or rounded with respect to the substrate on which the pillar is formed. The shape of the edge may be naturally formed when the pillar is etched. In general, when a substrate is etched, the shape of an edge of the substrate etched may be slanted, not perpendicular to the substrate, due to, for example, diffusion. The slanted edge may be used as a reflection surface.

The microarray may be any of the embodiments of a microarray according to the above description.

The method of obtaining light data from a microarray according to the present embodiment includes contacting a target material labeled with a light emitting material with a microarray, wherein the microarray includes a first fiducial mark and a region in which a probe material is immobilized and the first fiducial mark has a hydrophobic surface.

The contacting may be performed under a condition that is appropriately controlled according to types of a target material and a probe material. For example, in regard to hybridization of a DNA probe and a target DNA, a fluorescent light-labeled target DNA is mixed with a hybridization buffer, and then the mixture is heat treated to thermally denature the target DNA and then, the resultant solution is added to a microarray and maintained at an appropriate temperature while remaining hydrated, thereby forming a hybrid DNA. After the reaction is complete, unreacted materials may be removed by washing the microarray with a salt concentration and temperature-controlled solution.

The method of obtaining light data from a microarray according to the present embodiment also includes irradiating light to the microarray to measure light generated from the microarray. Embodiments include configurations wherein the light measured may be fluorescent light and/or reflected light. Embodiments include configurations wherein the irradiation light may be a laser light or light of any wavelength. When the second fiducial mark includes at least one pillar, the measurement light may be a reflected light. The irradiating of light to the microarray and the measuring of light emitted therefrom may be performed using a known method.

In one embodiment, the light irradiation may be performed at a light irradiation angle for detecting an interaction between a target material and a probe material in a probe spot. Embodiments of the light irradiation angle may be in the range of about 0° to about 45° with respect to the surface of the substrate. The irradiation light may be light of any wavelength or an excitation light of a predetermined wavelength corresponding to an excitation wavelength of a fluorescent material. In one embodiment, the measurement light may be measured at an angle in the range of about 45° to about 135° with respect to the surface of the substrate.

The light may be measured using a light receiving device. Embodiments of the light receiving device may include a photomultiplier tube, a photodiode, a charge coupled device (“CCD”) or other similar devices. When an excitation light that is appropriate for a fluorescent light mark is used to measure the reflected light, the reflected light and the fluorescent light may be simultaneously measured. In such an embodiment, the reflected light and the fluorescent light may be separated by a dichroic mirror, and a light receiving device for measuring the fluorescent light and a light receiving device for measuring the reflected light may be separately used. The measured light data may be provided in an image form, or in a digital form such that intensities of the reflected light is represented numerically.

The method of obtaining light data from a microarray according to the present embodiment also includes identifying the first fiducial mark from the obtained light data and identifying the location and range of a region in which a probe material is immobilized with reference to the identified first fiducial mark.

The method also includes identifying the first fiducial mark and, optionally the second fiducial mark from the obtained light data and identifying the region in which a probe material is immobilized with reference to the identified first fiducial mark and, optionally, the second fiducial mark.

In regard to the identifying, the first fiducial mark may be identified by referring to how low the light intensity is compared to the light intensity of the surroundings, that is, a degree of darkness. For example, in one embodiment the first fiducial mark may have a brightness equal to or lower than that of the region in which a probe material is immobilized. The degree of darkness may be appropriately selected according to a light emitting material used. That is, in consideration of predetermined information on a first fiducial mark and other regions, the location and range showing low light intensity is identified as the first fiducial mark, and the location and range of the first fiducial mark is referred to specify other regions in which a probe is immobilized. The identified information on the other regions is compared to the predetermined information on the first fiducial mark and other regions, it is determined whether the information on the other regions is the same as the predetermined information and correction of the information may be further made, if necessary. The predetermined information includes a predetermined location or range of the first fiducial mark, second fiducial mark and/or regions in which a probe is immobilized on the substrate, which are used during the manufacturing of the microarray.

In regard to the identifying step, the second fiducial mark may be identified by referring to how high the light intensity is compared to the surroundings compared to that of the region in which a probe material is immobilized. For example, in one embodiment the second fiducial mark may have a brightness equal to or higher than that of the region in which a probe material is immobilized. The degree of brightness may be appropriately selected according to a type of light-emitting material used. That is, in consideration of predetermined information on a second fiducial mark and other regions, the location and range having high light intensity is identified as a second fiducial mark, and the location and range of the second fiducial mark is used to specify a region in which other probes are immobilized. The identified information is compared to the predetermined information on the second fiducial mark and other regions, it is determined whether the information on the other regions is the same as predetermined information and correction of the information may be further made, if necessary. The predetermined information includes a predetermined location or range of the first fiducial mark, second fiducial mark and/or regions in which a probe is immobilized on the substrate, which are used during the manufacturing of the microarray.

In the identifying of the first fiducial mark and the second fiducial mark, the first fiducial mark may be identified by referring to how low the light intensity is compared to the surroundings, and the second fiducial mark may be identified by referring to how high the light intensity is compared to the surroundings and the first fiducial mark and the second fiducial mark may be identified by referring to the relative location of the first fiducial mark and second fiducial mark. In particular, the first fiducial mark and the second fiducial mark may be identified by referring to whether the first fiducial mark and second fiducial mark are adjacent to each other. In addition, the first fiducial mark and second fiducial mark may be identified by referring to the shape, for example, letter or symbol, of the first fiducial mark and second fiducial mark.

According to another embodiment, a microarray includes a first distinct region, a second distinct region and a third distinct region on a substrate, wherein a probe nucleic acid is immobilized on the third distinct region, the probe nucleic acid has a sequence complementary to that of a target nucleic acid, a binding force between the first distinct region and a target nucleic acid labeled with a detectable label or a target material labeled with a detectable label is weaker than a binding force between the second distinct region and the target material labeled with a detectable label, and the binding force between the second distinct region and the target material labeled with a detectable label is equal to or stronger than a binding force between the probe nucleic acid in the third distinct region and the target material labeled with a detectable label.

In regard to the first distinct region and the second distinct region, when reacted with the target nucleic acid labeled with a detectable label or the target material labeled with a detectable label, the detection signal obtained from the second distinct region is stronger than the detection signal obtained from the first distinct region. Due to the signal difference, the first distinct region and the second distinct region may be used as fiducial marks for identifying signals obtained from a microarray assay. The first distinct region and the second distinct region may also be referred to as a dark fiducial mark (“DF”) and a bright fiducial mark (“BF”), respectively. In addition, the third distinct region may be referred to as a data spot.

In the present exemplary embodiment, the detection signal may be a fluorescent light signal, and the fluorescent light signal obtained from the second distinct region may be stronger than the fluorescent light signal obtained from the first distinct region. The fluorescent light signal obtained from the second distinct region may be stronger than the fluorescent light signal obtained from the first distinct region by 10% or more. Exemplary embodiments include configurations wherein the fluorescent light signal obtained from the second distinct region may be stronger than the fluorescent light signal obtained from the first distinct region by about 20%. Exemplary embodiments include configurations wherein the fluorescent light signal obtained from the second distinct region may be stronger than the fluorescent light signal obtained from the first distinct region by about 30%. Exemplary embodiments include configurations wherein the fluorescent light signal obtained from the second distinct region may be stronger than the fluorescent light signal obtained from the first distinct region by about 40%. Exemplary embodiments include configurations wherein the fluorescent light signal obtained from the second distinct region may be stronger than the fluorescent light signal obtained from the first distinct region by about 50%. Exemplary embodiments include configurations wherein the fluorescent light signal obtained from the second distinct region may be stronger than the fluorescent light signal obtained from the first distinct region by about 100%. Exemplary embodiments include configurations wherein the fluorescent light signal obtained from the second distinct region may be stronger than the fluorescent light signal obtained from the first distinct region by about 200% or more.

Embodiments of the detectable label may be an optical label, a radioactive label, an enzyme for converting a substrate into a chromophore material or various other similar labels. In one embodiment, the optical label may include a fluorescent material. Examples of the enzyme may include an alkaline phosphatase and a horseradish peroxidase.

The first, second and third distinct regions may each have a dimension of about 0.1 μm to about 10 μm, e.g., the width and/or length of the regions may be within the described range. In the embodiment wherein the first, second and third distinct regions are circular, the dimension refers to a diameter of the region. However, if the first, second and third distinct regions are not circular, the dimension refers to a shortest segment line formed by a line passing through the weight center of the regions and a boundary line of the regions.

In regard to the first distinct region and the second distinct region, the first distinct region and the second distinct region may be arranged such that when reacted with the target nucleic acid labeled with a detectable label or the target material labeled with a detectable label, detection signals obtained from the first distinct region and the second distinct region are discerned from a detection signal obtained from the third distinct region.

The combination may have such an arrangement that when subjected to the same reaction, the detection signal obtained from the third distinct region has an arrangement having low probability for accidentally having the same arrangement. Herein, the “arrangement having low probability for accidentally having the same arrangement” means that the arrangement of the detection signals obtained after the target nucleic acid labeled with a detectable label or the target material labeled with a detectable label is reacted with the probe nucleic acid immobilized on the third distinct region is an arrangement that is probabilistically statistically insignificant, e.g., outside two or more standard deviations from the expected results. In one exemplary embodiment, the arrangement may have a letter or symbol shape. Embodiments include configurations wherein the first distinct region may surround the second distinct region or have an opposite shape to that of the second distinct region.

The combination may be arranged in each of a plurality of panels of the microarray wherein each of the panels includes a plurality of combinations. For example, if each of the panels of a microarray is tetragonal, the combinations may be arranged in respective four corners of each panel. Herein the “panel” refers to a unit region by which a detecting apparatus reads a signal from a microarray that has been reacted with a target nucleic acid. For example, in an embodiment wherein a detecting apparatus is a camera for measuring fluorescent light, the panel refers to a unit region by which the camera reads a fluorescent light signal from a microarray that has been reacted with a target nucleic acid. The microarray may consist of a plurality of panels, and in such an embodiment, a signal obtained from the microarray may be assayed by combining signals obtained from the panels.

The first distinct region may include a hydrophobic material, and the target nucleic acid labeled with a detectable label and the target material labeled with a detectable label may include a hydrophilic material.

Also, the second distinct region may be immobilized with a material that is binding to the target material labeled with a detectable label or may have a surface characteristic that binds to the target material labeled with a detectable label. For example, in one embodiment the second distinct region may be immobilized with a biotin, and the target material labeled with a detectable label may be streptavidin labeled with a detectable label. Since a binding force between biotin and streptavidin is, in general, stronger than that of a probe nucleic acid and a target nucleic acid, a signal obtained from the binding of biotin and streptavidin may be stronger than a signal obtained from the binding of the probe nucleic acid and the target nucleic acid. In addition, the second distinct region may be immobilized with a probe that is longer than a probe nucleic acid, and the target material labeled with a detectable label may be a nucleic acid complementary to the longer probe. Embodiments include configurations wherein the length of the probe nucleic acid immobilized in the first distinct region may be in the range of about 10 by to about 50 bp. In one embodiment, the length of the probe nucleic acid immobilized in the first distinct region may be in the range of about 10 by to about 40 bp. In another embodiment, the length of the probe nucleic acid immobilized in the first distinct region may be in the range of about 10 by to about 30 bp. Also, a probe nucleic acid immobilized in the second distinct region may be longer than a probe nucleic acid immobilized in the first distinct region by about 10 by or more. In one embodiment, a probe nucleic acid immobilized in the second distinct region may be longer than a probe nucleic acid immobilized in the first distinct region by about 20 bp. In another embodiment, a probe nucleic acid immobilized in the second distinct region may be longer than a probe nucleic acid immobilized in the first distinct region by about 30 bp. In another embodiment, a probe nucleic acid immobilized in the second distinct region may be longer than a probe nucleic acid immobilized in the first distinct region by about 100 bp. In another embodiment, a probe nucleic acid immobilized in the second distinct region may be longer than a probe nucleic acid immobilized in the first distinct region by about 200 by or more.

The microarray uses a reduced region for a fiducial mark, signals obtained from the microarray may be identified for a relatively shorter time period and contamination between panels is reduced.

According to another embodiment, a method of assaying a microarray signal includes; obtaining a signal from a reaction product produced by reacting the microarray described above with a sample including a target nucleic acid labeled with a detectable label and a target material labeled with a detectable label, and discerning signals obtained from a third distinct region by referring to signals obtained from first and second distinct regions.

The present embodiment of a method of assaying a microarray signal includes obtaining a signal from a reaction product produced by reacting the microarray described above with a sample including a target nucleic acid labeled with a detectable label and a target material labeled with a detectable label. Embodiments include configurations wherein the reaction may be a hybridization reaction, and a condition for the hybridization reaction may be well known in the art. For example, in one embodiment the hybridization reaction may occur in a hybridization buffer overnight at a temperature of about 4° C. The microarray is substantially similar to that described above. A signal may be obtained using an appropriate method that may vary according to a label material used. For example, in an embodiment wherein a fluorescent light label is used, a fluorescent light generated when an excitation light is irradiated to the fluorescent light label is measured. In one embodiment, the measurement may be performed using a camera.

Hereinafter, one or more embodiments of the present invention will be described in detail with reference to the following embodiments. However, these embodiments are illustrative embodiments and not intended to limit the purpose and scope of the one or more embodiments of the present invention described above.

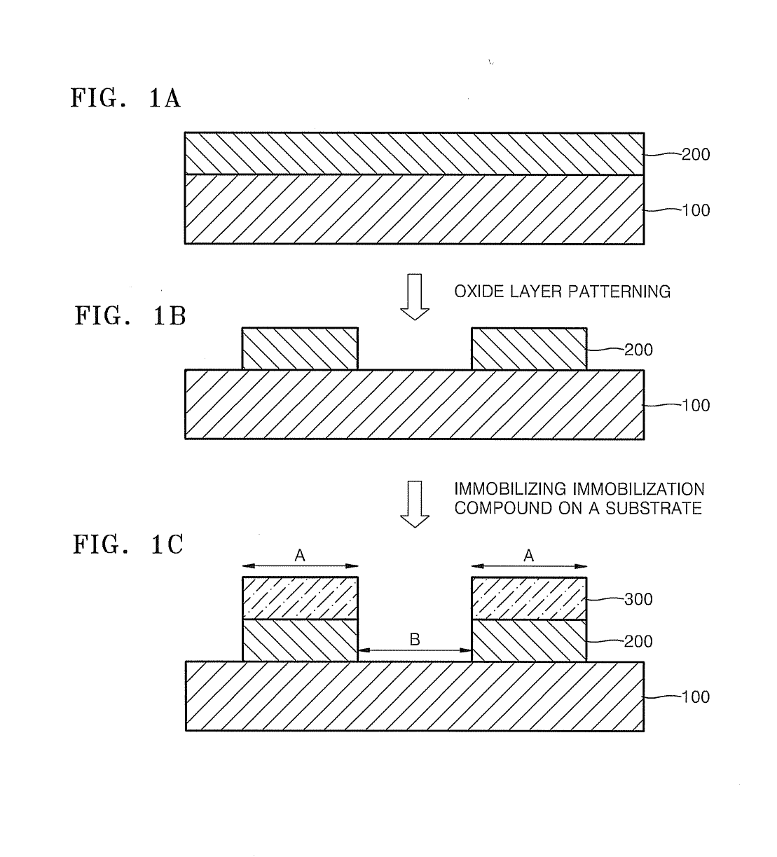

FIGS. 1A-C are a series of cross-sectional views illustrating a method of manufacturing a substrate 100 for a microarray, wherein the substrate 100 includes a first fiducial mark and a region in which a probe material is to be immobilized. Referring to FIG. 1A, first, an oxide layer 200 is formed on the substrate 100. Embodiments of the substrate 100 may include silicon, and embodiments of the oxide layer 200 may include silicon dioxide. As shown in FIG. 1B, the oxide layer 200 may be patterned using a known method. For example, embodiments include configurations wherein a photoresist may be coated on an oxidation film to form a photoresist coating layer and then the photoresist coating layer is exposed using a mask having a pattern for a first fiducial mark and developed. Then, a region that is not protected by the photoresist is etched. Embodiments include configurations wherein the etching may be a dry etch using, for example, fluoroalkane such as tetrafluoromethane. As a result of the etching, the substrate 100 has a hydrophobic surface, or a recess portion coated with a hydrophobic material as illustrated in region B of FIG. 1B, which functions as a first fiducial mark. Then, a probe immobilization compound 300 is applied to the substrate 100 such that the probe immobilization compound 300 is immobilized on the oxide layer 200 of the substrate 100. In this regard, the region B is hydrophobic and does not react with the probe immobilization compound 300. Thus, the probe immobilization compound 300 that does not react may be removed by washing.

Referring to FIG. 1C, region A, which functions as a second fiducial mark, is a bright fiducial mark. That is, when light data is obtained from an irradiated microarray, the region A produces bright light data, and functions as a bright fiducial mark. The region A may have a structure including at least one pillar, and when irradiated, the pillar structure may emit strong reflective light, as will be described in more detail with respect to the rightmost images in FIGS. 4A-C. Since the pillar structure provides bright light data, the region A is used as a bright fiducial mark. For the patterning process, when the oxide layer 200 is patterned, the at least one pillar structure may also be simultaneously or sequentially patterned using the same patterning process. Although FIGS. 1A-C illustrates an embodiment in which a probe immobilization compound is immobilized in the region A, if a structure having a high reflection rate, such as a structure including at least two pillars, is provided, the probe immobilization compound may not be immobilized in the region A.

Also, the region A may be used as a bright fiducial mark by immobilizing an immobilization compound thereon that is different from a probe immobilization compound that is immobilized in a probe immobilization region. For example, the immobilization compound 300 may be selected from materials that strongly interact with a target material, embodiments of which include avidin and streptoavidin. In such an embodiment, when a target material is assayed, the bright fiducial mark may produce bright light data by reacting a target material corresponding to a immobilization compound, for example, avidin or streptoavidin, with a fluorescent light-labeled biotin. Materials that strongly interact with each other, for example, biotin and either avidin or streptoavidin have a binding force much stronger than that of conventionally known assay materials, for example, a nucleic acid probe having a length of about 10 bp to about 50 bp and a nucleic acid and thus, a signal obtained from the materials that strongly interact with each other is also strong. For example, in one embodiment, the binding force of biotin and either avidin or streptoavidin is, for example, 10 or more times stronger than that of a nucleic acid probe having a length of about 10 bp to about 50 bp and a nucleic acid. In one embodiment the binding force of biotin and either avidin or streptoavidin is 100 times stronger than that of a nucleic acid probe having a length of about 10 bp to about 50 bp and a nucleic acid. In one embodiment the binding force of biotin and either avidin or streptoavidin is 1,000 times stronger than that of a nucleic acid probe having a length of about 10 bp to about 50 bp and a nucleic acid. In one embodiment the binding force of biotin and either avidin or streptoavidin is 10,000 or more times stronger than that of a nucleic acid probe having a length of about 10 bp to about 50 bp and a nucleic acid.

By combining light data from the region B that is a dark fiducial mark and light data from the region A that is a bright fiducial mark, the dark fiducial mark and the bright fiducial mark may be easily identified. Thus, since a relative location and range from the fiducial marks are known when the microarray is manufactured, the region in which a probe material is immobilized may be easily identified.

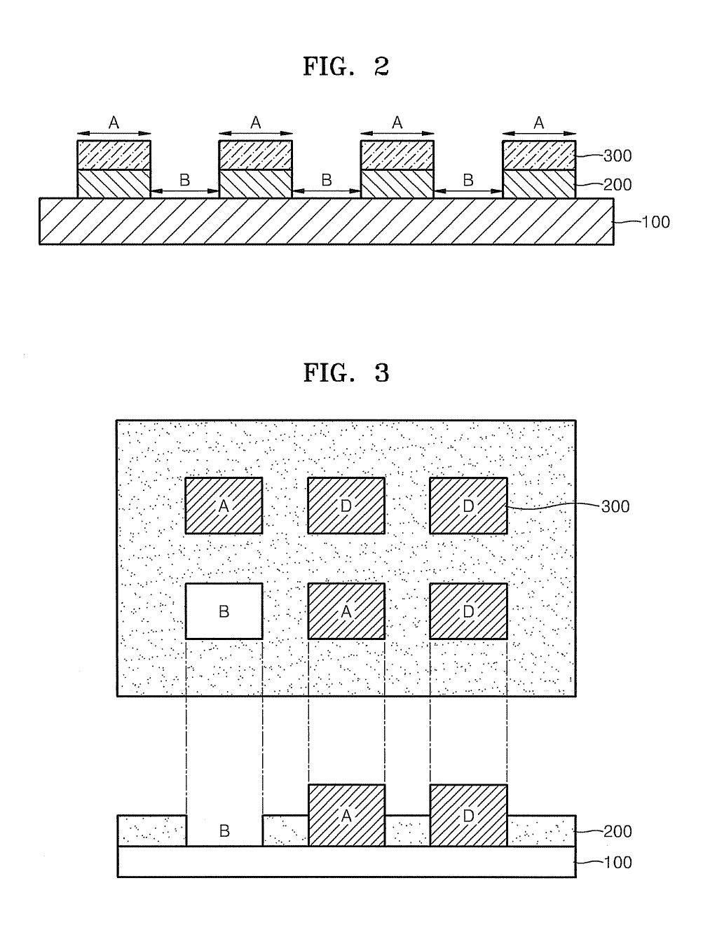

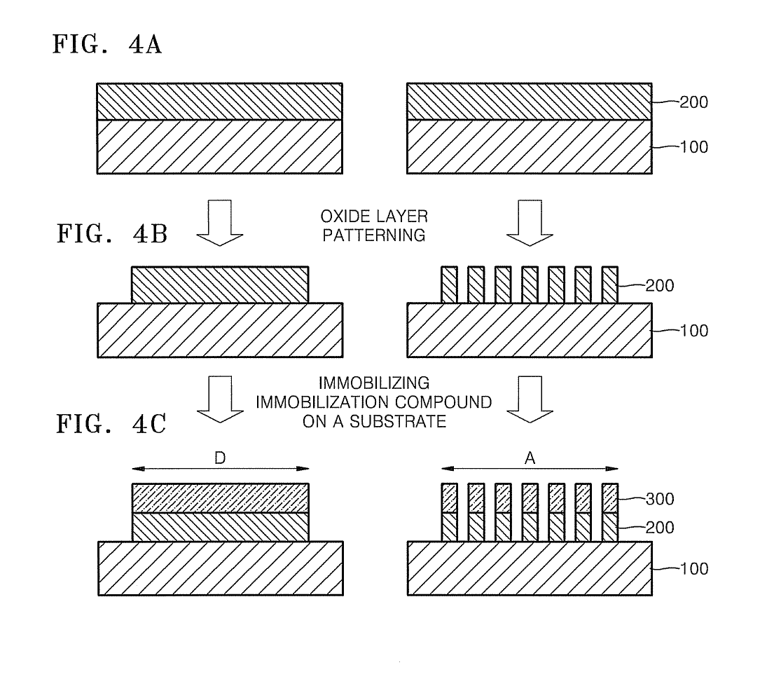

FIGS. 2 and 3 are diagrams illustrating at least one embodiment of a substrate for a microarray or a microarray. Referring to FIG. 2, a dark fiducial mark B may be located between bright fiducial marks A, or between regions D in which a probe is immobilized, or between the bright fiducial mark A and the region D in which a probe is immobilized. FIG. 3 shows an embodiment in which the dark fiducial mark B is formed as a recess region formed only in an oxide layer, and the bright fiducial mark A and the region D in which probes are immobilized are formed. Referring to FIG. 3, the surroundings of the region D in which a probe is immobilized are etched. However, in other embodiments, the surroundings of the region D in which a probe is immobilized may not be etched.

FIGS. 4A-C are diagrams illustrating an example of the bright fiducial mark A having a structure including at least one pillar and an example of a method of manufacturing the bright fiducial mark A. Referring to FIGS. 4A-C, the bright fiducial mark A and the region D in which a probe is immobilized are formed in the same patterning process. That is, a mask used in the patterning process may include, in addition to a pattern for the region D in which a probe is immobilized, a pattern for the bright fiducial mark A and/or the dark fiducial mark B.

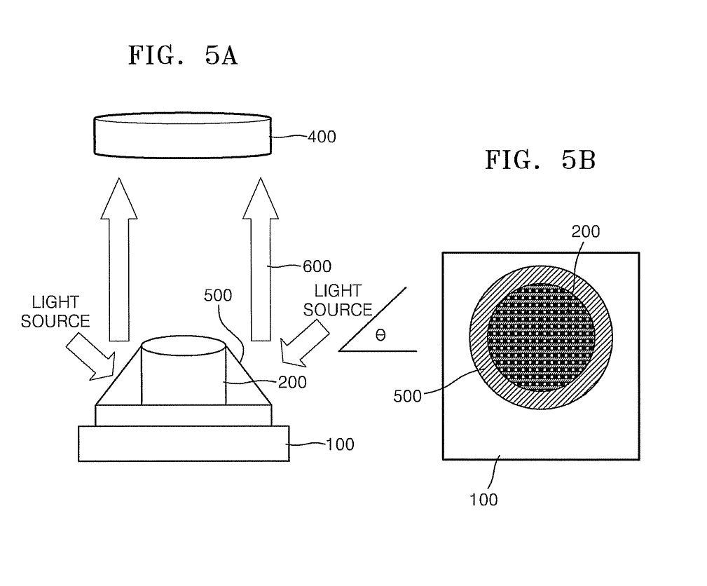

FIGS. 5A and B are diagrams illustrating a mechanism in which a pillar structure functions as a bright fiducial mark. Referring to FIG. 5, when light is irradiated to a circumference of a pillar at an angle of θ with respect to a horizontal plane of the pillar, an edge of the pillar constitutes a reflection surface 500, and provides a reflected light 600, and the reflected light 600 may be measured using a light receiving device 400, for example, a camera as shown in FIG. 5A. In FIG. 5A, the edge of the pillar is enlarged for clarity. Since the reflected light 600 has higher intensity than a fluorescent light, even when a reflected light is exposed to a light measurement device for a short time period, strong light intensity is measured. The intensity of the reflected light measured may be, in general, about 1000 to about 10,000 or more times greater than that of fluorescent light. In one embodiment, when the reflected light is measured an optical filter may not be used. FIG. 5B shows a top plan view image of a bright fiducial mark having a structure including at least two pillars obtained by measuring light reflected therefrom. As in the right illustration of FIG. 5B, the intensity of light increases in the following sequence; light reflected from the substrate 100, light reflected from the reflection surface 500, and light reflected from an inner portion 200 of the pillar structure.

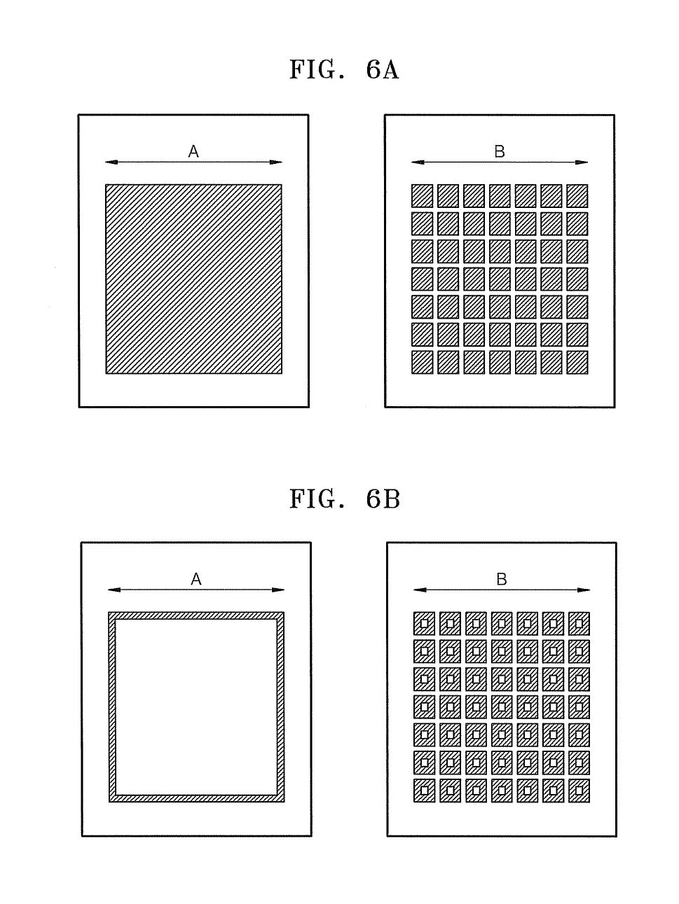

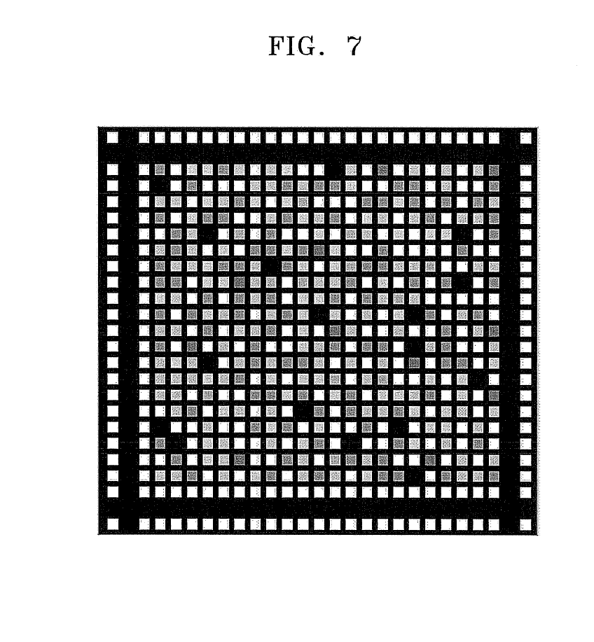

FIGS. 6A and B are schematic views of fluorescent light and reflected light images obtained from the same structure, respectively. As shown in FIG. 6A, when a material labeled with a light emitting dye, for example, a fluorescent light dye is immobilized in regions A and B, the regions A and B are exposed to an excitation light and fluorescent lights emitted therefrom are measured. As shown in FIG. 6A, light is uniformly distributed in the entire level surface of the structure. However, as shown in FIG. 6B, light is irradiated to circumferences of regions A and B at an angle of about 45° with respect to a horizontal cross section plane of the pillar and light is reflected from an upper edge of the structure and the reflected light is measured. As shown in FIG. 6B, light emitted from a surface of the upper edge of the structure has a high intensity. In FIGS. 6A and 6B, each of the regions A and B is a bright fiducial mark having at least one pillar structure.

FIG. 7 shows an example of a microarray assay image. The microarray assay image may be a fluorescent image obtained in the following manner. A microarray is hybridized with a fluorescent light material-labeled target nucleic acid, and then the hybridization product is exposed to an excitation light corresponding to the fluorescent light material, and light emitted therefrom is measured. Referring to FIG. 7, a dark fiducial mark has a dark square shape and consists of distinct regions located in the rows and columns immediately adjacent to the edges of the microarray assay image, e.g., the dark square shapes form columns and rows, such as the second and second to last rows and the second and second to last columns; a bright fiducial mark has a letter L-shape and consists of distinct regions located in the rows and columns third from left and bottom edges of the microarray assay image, e.g., the bright square shapes immediately interior to the second column and the second to last row; and the dark fiducial mark and the L-shaped bright fiducial mark are adjacent to each other. Thus, even when light emitted from data spots has a brightness equivalent to or higher than the bright fiducial mark, the location of the bright fiducial mark is identifiable. That is, by using a combination of a dark fiducial mark and a bright fiducial mark, the location of fiducial marks is more easily identified in a microarray assay image, and thus, the number of spots used is also reduced. Since the number of spots used in fiducial marks is reduced, the effect of a reaction of fiducial marks and a target material contained in a sample on a reaction of data spots and of the target material contained in the sample is reduced and thus, intensity or accuracy of data spots is increased. FIG. 7 shows an image of one panel in a microarray.

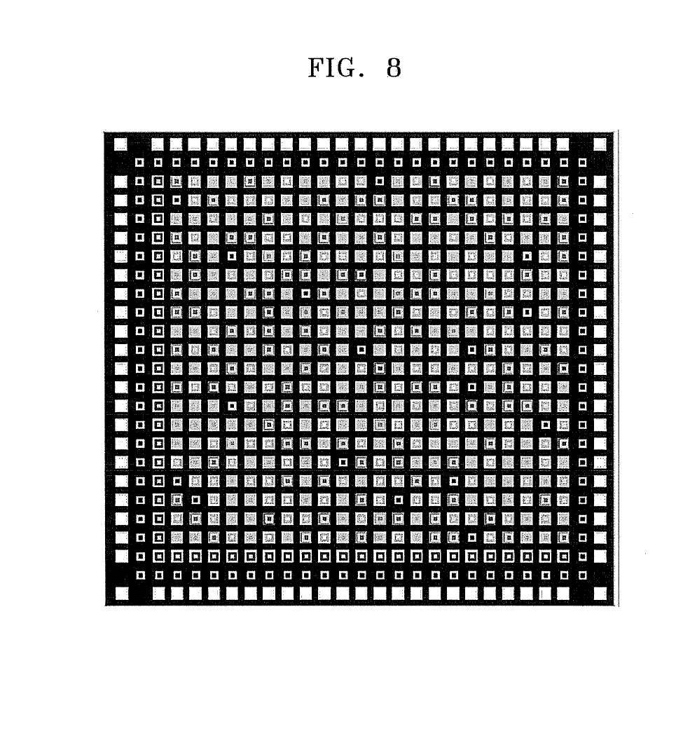

FIG. 8 shows a gridding embodiment in which fiducial marks and data spots are accurately arranged by referring to the fiducial marks illustrated in FIG. 7. Once the location or shape of fiducial marks is identified, location of other data spots is identified using a known method. The location or shape of fiducial marks may be identified using the naked eye or a reference file that stores information on the fiducial marks. As used herein, the reference file refers to a file that stores information on the shape of fiducial marks arranged when a microarray is produced and information on the relative location of fiducial marks and data spots. Referring to FIG. 7, in the square-shaped dark fiducial mark and the L-shaped bright fiducial mark, and a data spot region, a grid is allocated to accurately correspond to respective spots. When a target material is assayed using a microarray, information on the target material is assayed by referring to a signal of the grid, for example, a fluorescent light signal.

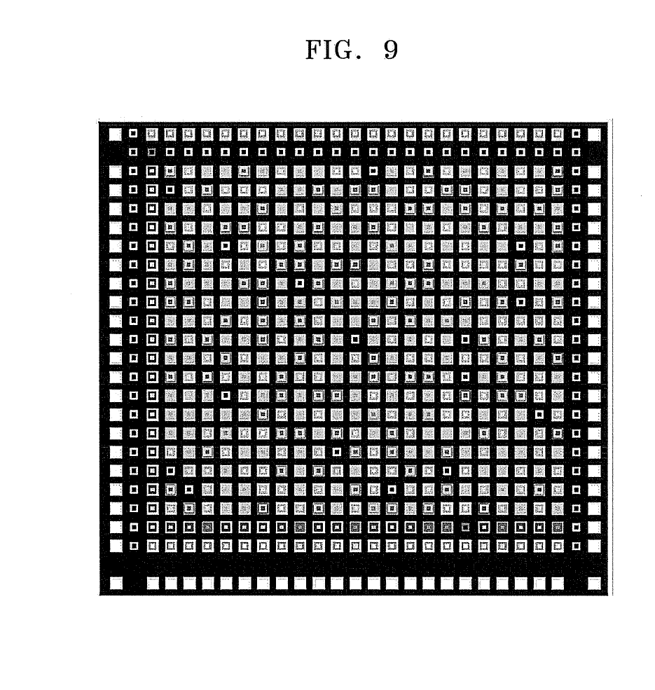

FIG. 9 illustrates a grid in which the fiducial marks and data spots are inaccurately arranged by referring to the fiducial marks in the image shown in FIG. 7. Referring to FIG. 9, compared to the dark fiducial mark formed in the microarray, the lower side of the dark fiducial mark is shifted upward such that the lower side of the dark fiducial mark includes spots in a third row, one row above the desired location from the lower edge of the image, and the lower side of the bright fiducial mark is shifted upward such that the lower side of the bright fiducial mark includes of spots in a fourth row, one row above the desired location from the lower edge of the image. As a result, actual spot locations in the microarray are mismatched with spot locations in a grid. Thus, when signals read from the grid are analyzed, a target material in a sample is inaccurately analyzed.

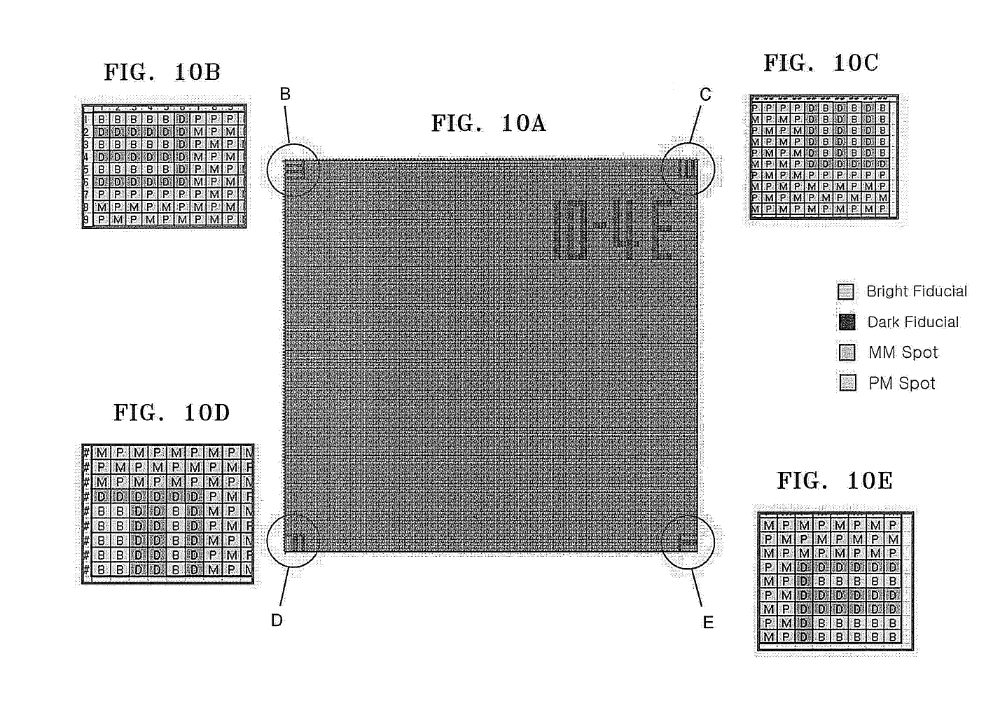

FIGS. 10A-E shows an image of a panel of a microarray, wherein the panel includes a plurality of combinations of a dark fiducial mark and a bright fiducial mark and the combinations have different shapes. FIGS. 10B-E show enlarged views of the areas labeled B-E of FIG. 10A. Referring to FIGS. 10A-E, each combination of a dark fiducial mark and a bright fiducial mark is positioned at four corners of the image of the panel and the four combinations have different shapes. In addition, FIG. 10A illustrates that dark fiducial marks may be used to form alphanumeric characters on the panel of the microarray in order to provide additional identification, as shown in FIG. 10A, the characters spell “10-4E”. In FIGS. 10A-E, B is a bright fiducial mark spot, and D is a dark fiducial mark spot, and M and P are data spots. As used in FIGS. 10A-E, M is a mismatch spot and P is a perfect match spot. FIG. 10A shows an image of one panel of a microarray, including a total of 144 fiducial mark spots (B:D=60:84). As described above, the dark fiducial mark may be a region formed by removing an oxide layer from a substrate on which the oxide layer is formed. Embodiments include configurations wherein the region may be a surface of the substrate itself from which the oxide layer is removed, or a surface coated with a hydrophobic material. In the embodiments wherein it is used, the hydrophobic material may be derived from a dry etching material, such as fluorocarbon. In one embodiment, the fluorocarbon may be tetrafluoromethane. Embodiments include configurations wherein a dry etching process is performed using a plasma reaction of a material, which is well known.

The substrate may have a surface on which a probe immobilization compound is immobilized. The surface may be the entire surface excluding the surface of the first fiducial mark, or a surface on which a probe is to be immobilized. Embodiments of the probe immobilization compound may include at least one compound selected from the group consisting of biotin, avidin, streptavidin, poly L-lysine, and compounds having an amino group, an aldehyde group, a thiol group, a carbonyl group, a succinimide group, a maleimide group, an epoxide group, or an isothiocyanate group. Examples of a compound including an amino group include 3-aminopropyltrimethoxysilane, EDA, DETA, 3-(2-aminoethylaminopropyl) trimethoxysilane, and 3-aminopropyltriethoxysilane. Examples of a compound including an aldehyde group include glutaraldehyde. Examples of a compound including a thiol group include MPTS. Examples of a compound including an epoxide group include 3-glycidoxypropyltrimethoxysilane. Examples of a compound including an isothiocyanate group include PDITC. Examples of compounds including succinimide and maleimide groups include DSC and SMPB. As shown in FIGS. 10A-E, a dark fiducial mark may be positioned near the first fiducial mark.

Embodiments include configurations wherein the second fiducial mark may be defined by patterning a surface of the substrate. The patterning may be performed using a known method. For example, in one embodiment the patterning may be performed by photolithography. As a result of the patterning, the second fiducial mark may have a pillar structure formed by removing a portion of the surface of the substrate near the second fiducial mark by etching. A horizontal cross-section of the pillar structure may be, for example, circular or tetragonal such as rectangular or square shaped, but the shape of the pillar structure is not limited thereto.

When a plurality of different combinations illustrated in FIGS. 10A-E, for example, combinations that may not occur accidentally in data spots are used, the probability of misgridding is low. In an experiment for obtaining the results shown in FIGS. 10A-E, no misgridding occurred in 216 panels (72 panels/microarray×3 microarrays). When a plurality of different combinations is used, since a smaller region is used as a fiducial mark spot per panel, more data spots are formed. In addition, since the number of fiducial mark spots is reduced, the time required for identifying grids is reduced. When a plurality of different combinations is used, confusion occurring when adjacent panels are differentiated may be reduced.

As described above, according to the one or more of the above embodiments, using a substrate for a microarray, a microarray from which light data is easily obtained can be manufactured.

By using a method of manufacturing a substrate for a microarray according to an above described embodiment, a microarray from which light data is easily obtained can be produced.

By using a microarray according to an above described embodiment, light data is easily obtained.

By using a method of manufacturing a microarray, according to an above described embodiment, a microarray from which light data is easily obtained can be produced.

By using a method of obtaining light data according to an above described embodiment, light data can be easily obtained from a microarray.

It should be understood that the embodiments described therein should be considered in a descriptive sense only and not for purposes of limitation. Descriptions of features or aspects within each embodiment should typically be considered as available for other similar features or aspects in other embodiments.

What is claimed is:

1. A substrate that is used to produce a microarray, the substrate comprising:
a first fiducial mark disposed on the substrate; and
a probe immobilization region disposed on the substrate,
wherein a surface of the first fiducial mark is hydrophobic and a probe immobilization compound is immobilized on the probe immobilization region.

2. The substrate of claim 1, wherein the first fiducial mark comprises a region of the substrate from which an oxide layer is removed.

3. The substrate of claim 2, wherein the region of the substrate from which an oxide layer is removed comprises one of a surface of the substrate and a surface of the substrate coated with a hydrophobic material.

4. The substrate of claim 1, further comprising a second fiducial mark.

5. The substrate of claim 4, wherein the second fiducial mark comprises at least two pillars formed on the surface of the substrate.

6. The substrate of claim 4, wherein the second fiducial mark comprises a material that strongly interacts with a target material immobilized on the surface of the substrate.

7. A microarray comprising:
a first fiducial mark disposed on a substrate; and
a region of the substrate on which a probe material is immobilized,
wherein a surface of the first fiducial mark is hydrophobic.

8. The microarray of claim 7, wherein the first fiducial mark comprises a region of the substrate from which an oxide layer is removed.

9. The microarray of claim 8, wherein the region of the substrate from which an oxide layer is removed comprises one of a surface of the substrate and a surface of the substrate coated with a hydrophobic material.

10. The microarray of claim 7, further comprising a second fiducial mark.

11. The microarray of claim 10, wherein the second fiducial mark comprises at least two pillars formed on the surface of the substrate.

12. The microarray of claim 10, wherein the second fiducial mark comprises a material which strongly interacts with a target material and is immobilized on the surface of the substrate.

13. The microarray of claim 11, wherein adjacent pillars of the at least two pillars are spaced apart by an interval of about 0.1 μm to about 1000 μm and a dimension of a cross-section of each pillar is in the range of about 0.1 μm to about 1000 μm.

14. A method of manufacturing a substrate for a microarray, the method comprising:
providing a substrate on which an oxide layer is formed, wherein the substrate has a surface which is hydrophobic;
coating photoresist on the oxide layer to form a photoresist layer;
irradiating light to the photoresist layer through a mask;
developing the photoresist layer and etching a portion of the oxide layer which is not protected by the photoresist layer to expose the surface of the substrate; and
immobilizing a probe immobilization compound on a portion of the substrate that does not comprise the surface which is hydrophobic.

15. The method of claim 14, wherein the etching comprises a dry etching process using a hydrophobic material.

16. A method of manufacturing a probe microarray, the method comprising:
providing a substrate on which an oxide layer is disposed, wherein the substrate has a surface which is hydrophobic;
coating photoresist on the oxide layer to form a photoresist layer;
irradiating light to the photoresist layer through a mask;
developing the photoresist layer and etching a portion of the oxide layer which is not protected by the photoresist layer to expose the surface of the substrate;
immobilizing a probe immobilization compound on a portion of the substrate that does not comprise the surface which is hydrophobic; and
immobilizing a probe material on a plurality of distinct regions on the portion of the substrate on which the probe immobilization compound is immobilized.

17. A method of manufacturing a substrate for a microarray, the method comprising:
providing a substrate on which an oxide layer is disposed;
coating photoresist on the oxide layer to form a photoresist layer;
irradiating light to the photoresist layer through a mask;
developing the photoresist layer and etching a portion of the oxide layer which is not protected by the photoresist layer to expose a surface of the substrate, wherein the etching comprises a dry etching process using a hydrophobic material; and
immobilizing a probe immobilization compound on a portion of the substrate that does not comprise a surface that is hydrophobic.

18. The method of claim 17, wherein the hydrophobic material comprises fluorocarbon.

19. A method of manufacturing a probe microarray, the method comprising:
providing a substrate on which an oxide layer is disposed;
coating photoresist on the oxide layer to form a photoresist layer;
irradiating light to the photoresist layer through a mask;
developing the photoresist layer and etching a portion of the oxide layer which is not protected by the photoresist layer to expose a surface of the substrate, wherein the etching comprises a dry etching process using a hydrophobic material;
immobilizing a probe immobilization compound on a portion of the substrate which does not comprise a surface which is hydrophobic; and
immobilizing a probe material on a plurality of distinct regions on the portion of the substrate on which the probe immobilization compound is immobilized.

20. A method of obtaining light data from a microarray comprising a first fiducial mark, a second fiducial mark and a region in which a probe material is immobilized, the method comprising:
contacting a target material labeled with a light emitting material with the microarray, wherein the first fiducial mark has a hydrophobic surface;
irradiating light to the microarray;
measuring light generated from the microarray due to the irradiated light in order to generate light data;
identifying the first fiducial mark and the second fiducial mark from the light data;
identifying the region in which a probe material is immobilized with reference to the identified first and second fiducial marks; and
obtaining light data from the identified region in which a probe material is immobilized.

21. The method of claim 20, wherein, in the identifying of the first fiducial mark and the second fiducial mark, the first fiducial mark is identified by referring to a degree of how low the light intensity of the first fiducial mark is compared to regions surrounding the first fiducial mark.

22. The method of claim 20, wherein, in the identifying of the first fiducial mark and the second fiducial mark, the second fiducial mark is identified by referring to how high the light intensity of the second fiducial mark is compared to regions surrounding the second fiducial mark.

23. The method of claim 20, wherein, in the identifying of the first fiducial mark and the second fiducial mark, the first fiducial mark is identified by referring to how low the light intensity of the first fiducial mark is compared to regions surrounding the first fiducial mark, and the second fiducial mark is identified by referring to how high the light intensity of the second fiducial mark is compared to the regions surrounding the first fiducial mark and the first fiducial mark and the second fiducial mark are identified by the relative location of the first and second fiducial marks to each other.

24. The method of claim 20, wherein the second fiducial mark comprises at least two pillars formed on a surface of a substrate.

25. The method of claim 20, wherein the second fiducial mark comprises a material that strongly interacts with the target material immobilized on the surface of the substrate.

26. A microarray comprising:
a first distinct region disposed on a substrate;
a second distinct region disposed on the substrate; and
a third distinct region disposed on the substrate,
wherein a probe nucleic acid is immobilized on the third distinct region, the probe nucleic acid has a sequence complementary to that of a target nucleic acid, a binding force between the first distinct region and a target nucleic acid labeled with one of a detectable mark and a target material labeled with a detectable mark is weaker than a binding force between the second distinct region and the target material labeled with a detectable mark, and the binding force between the second distinct region and the target material labeled with a detectable mark is equal to or stronger than a binding force between the probe nucleic acid in the third distinct region and the target material labeled with a detectable mark.

27. The microarray of claim 26, wherein a detection signal obtained from the second distinct region is stronger than a detection signal obtained from the first distinct region when the first distinct region and the second distinct region are reacted with the target nucleic acid labeled with one of a detectable mark and the target material labeled with a detectable mark.

28. The microarray of claim 27, wherein when the detection signal comprises a fluorescent light signal, the fluorescent light signal obtained from the second distinct region is stronger than the fluorescent light signal obtained from the first distinct region.

29. The microarray of claim 26, wherein a combination of the first distinct region and the second distinct region are arranged such that when reacted with one of the target nucleic acid labeled with a detectable mark and the target material labeled with a detectable mark, detection signals obtained from the first distinct region and the second distinct region are discerned from a detection signal obtained from the third distinct region.

30. The microarray of claim 29, wherein the combination of the first distinct region and the second distinct region has an arrangement such that when subjected to the same reaction, the detection signal obtained from the third distinct region has low probability for accidentally having the same arrangement.

31. The microarray of claim 29, wherein the combination of the first distinct region and the second distinct region has an alphanumeric shape.

32. The microarray of claim 29, wherein the microarray comprises a plurality of panels, and a plurality of combinations of the first distinct region, the second distinct region and the third distinct region are arranged in each of the plurality of panels of the microarray.

33. The microarray of claim 32, wherein each of the panels of the microarray is tetragonal and the combinations of the first distinct region, the second distinct region and the third distinct region are arranged in respective four corners of each of the panels.

34. The microarray of claim 26, wherein the first distinct region comprises a hydrophobic material, and the target nucleic acid labeled with a detectable mark and the target material labeled with a detectable mark comprise a hydrophilic material.

35. The microarray of claim 26, wherein the second distinct region is immobilized with a material that binds to the target material labeled with a detectable mark.

36. The microarray of claim 26, wherein the second distinct region has a surface characteristic that binds to the target material labeled with a detectable mark.

37. The microarray of claim 26, wherein the second distinct region is immobilized with biotin, and the target material labeled with a detectable mark comprises streptavidin labeled with a detectable mark.

38. The microarray of claim 26, wherein the second distinct region is immobilized with a nucleic acid which is longer than a probe nucleic acid immobilized on the surface of the third distinct region, and the target material labeled with a detectable mark comprises a nucleic acid complementary to the probe nucleic acid.

38. A method of assaying a microarray signal wherein the microarray includes a first distinct region disposed on a substrate, a second distinct region disposed on a substrate, and a third distinct region disposed on a substrate, wherein a probe nucleic acid is immobilized on the third distinct region, the probe nucleic acid has a sequence complementary to that of a target nucleic acid, a binding force between the first distinct region and a target nucleic acid labeled with one of a detectable mark and a target material labeled with a detectable mark is weaker than a binding force between the second distinct region and the target material labeled with a detectable mark, and the binding force between the second distinct region and the target material labeled with a detectable mark is equal to or stronger than a binding force between the probe nucleic acid in the third distinct region and the target material labeled with a detectable mark, the method comprising:
obtaining a signal from a reaction product produced by reacting the microarray with a sample comprising at least one of the target nucleic acid labeled with a detectable mark and the target material labeled with a detectable mark; and
discerning signals obtained from the third distinct region by referring to signals obtained from the first distinct region and the second distinct region.

39. A method of manufacturing a microarray, the method comprising:
providing a substrate;
disposing an oxide layer on the substrate;
patterning the oxide layer to form at least two columns; and
disposing a probe immobilization compound on the at least two columns,
wherein a region between the at least two columns functions as a first fiducial mark, and the columns and probe immobilization compound function as a second fiducial mark having different light reflectance characteristics than the first fiducial mark.
